(19) United States
(12) Patent Application Publication
(10) Pub. No.: US 2004/0111507 A1
(43) Pub. Date: Jun. 10, 2004

(54) Method and system for monitoring network communications in real-time

(76) Inventors: Michael Villado, Arlington, VA (US); Michelle Sitrin, Arlington, VA (US)

Correspondence Address: MINTZ LEVIN COHN FERRIS GLOVSKY AND POPEO PC, 12010 SUNSET HILLS ROAD, SUITE 900, RESTON, VA, 20190, US

(21) Appl. No.: 10/310,181

(22) Filed: Dec. 5, 2002

(51) Int. Cl. G06F 15/173; G09G 5/00

(52) U.S. Cl. 709/224; 714/45; 345/736

(57) ABSTRACT

A system and method are provided for monitoring network communications in approximately real-time by capturing data that passes through a computer network and searching the data for at least one identification marker from a pre-determined set of identification markers. The information associated with the captured data is repackaged, viewed, and stored in a database. An authorized party may be provided with real-time alerts when predefined criteria are satisfied and the information may also be presented in reports that are organized and easy to read. As a result, the invention enables an authorized party to view pre-selected transactions in order to enforce Internet use policies.

### FIELD OF THE INVENTION

The present invention is directed to a method and system for monitoring network communications in real-time. In particular, the present invention is directed to a method and system that capture data passing through a computer network and search the data in real-time for a pre-determined set of identification markers.

### BACKGROUND OF THE INVENTION

The Internet has improved workplace productivity and has brought improvements in communications and research capabilities, making it easier to do business. The Internet also has made it easier for employees to spend time on non-work-related activities, bringing companies lost productivity, increased legal liabilities, and potential negative publicity from uncontrolled and unwanted Web surfing.

In view of the favorable aspects of the Internet, most organizations allow their employees to gain access to the Internet and attempt to curb improper use by requiring their employees to sign Internet use policies that include guidelines defining appropriate and inappropriate activities. Internet use policies are difficult to enforce, however, because there are limited systems in place for monitoring an employee's Internet use.

One method of restricting inappropriate Internet activity is to use filters that include a database of categorized Web sites that allow or deny access to entire categories of Web sites or to individual Web sites. The basic technique is to place a filter between the client browser and the outside world, such that the filter is able to evaluate any request for Web content against a set of pre-defined rules. If there is a violation of those rules, then the request is either blocked from establishing the connection, or the filtering software terminates the existing connection.

The filter may be supplemented with a monitor that works alongside the filter to inspect Internet traffic on the network and enforce the rules that have been established regarding blocked and non-blocked Web sites. A rule set is assigned to the monitor and the individual rules are assigned a priority, which determines the order in which they are evaluated by the monitor. The Internet traffic that is inspected by the monitor is typically logged and made available for generating feedback reports. Information from the traffic logs can then be analyzed for trends in bandwidth usage, frequently-accessed Web sites or pages, and time usage statistics.

Existing systems, however, require an accurate database of categorized Web sites in order to operate properly. The reality is that the current state of natural language processing is simply not capable of categorizing the content of Web sites with any degree of accuracy. The task of categorizing Web sites is further complicated because both the content of the Web site and the context of that content need to be considered when comparing Web sites. Also, the task of evaluating Web site content in real time introduces a great deal of unnecessary processing that slows down Web access because the destination Web site must be compared to a pre-categorized list of Web sites in order to decide whether to allow or deny a connection.

Furthermore, the task of categorizing Web sites is complicated by the rapidly changing nature of the Web, which requires constant work to update the content and maintain the accuracy of the database of pre-categorized Web sites. Categorizing Web sites also requires some degree of human intelligence to avoid the problems of over or under blocking. Other drawbacks exist.

### SUMMARY OF THE INVENTION

The invention overcomes these and other drawbacks of existing systems by improving the monitoring aspects of web usage to enable an authorized user, such as a network administrator, to view all the communications passing through a computer network in real-time, regardless of the defined rule set.

In one embodiment of the invention, a method of monitoring communication lines of a computer server in real-time is provided, wherein the data that passes through the communication lines is monitored to identify data packets having a pre-determined set of identification markers. The data packets having the pre-determined set of identification markers are captured, repackaged, and at least one metric is defined in order to organize and view the repackaged data packets. A user is also able to configure at least one feature for each metric to define a monitoring or notification process.

In another embodiment of the invention, a network communication monitoring system is provided having a plurality of terminal devices that are coupled to at least one application server through communication lines. In this embodiment, at least one of the application servers includes at least one module that monitors data passing through the communication lines in real-time to identify data packets having a pre-determined set of identification markers and to capture the identified data packets from the communication lines. Modules may also be provided to repackage the data packets having the pre-determined set of identification markers and to define at least one metric for viewing the repackaged data packets. The repackaged data packets are organized according to the at least one metric, wherein a user is able to configure at least one feature for each of the metrics.

These and other objects, features, and advantages of the invention will be apparent through the detailed description of the embodiments and the drawings attached hereto. It is also to be understood that both the foregoing general description and the following detailed description are exemplary and not restrictive of the scope of the invention.

### BRIEF DESCRIPTIONS OF THE DRAWINGS

Numerous other objects, features, and advantages of the invention should now become apparent upon a reading of the following detailed description when taken in conjunction with the accompanying drawings, a brief description of which is included below.

FIG. 1 illustrates an exemplary embodiment of a system diagram for the present invention.

FIG. 2 illustrates a flow chart schematic of the present invention.

FIG. 3 illustrates an exemplary screen-shot of the Control Center showing a user interface according to an embodiment of the present invention.

FIG. 4 illustrates an exemplary screen-shot of the Control Center showing a set up window in the user interface according to an embodiment of the present invention.

FIG. 5 illustrates an exemplary screen shot of the Control Center showing an alarm set up window in the user interface according to an embodiment of the present invention.

FIG. 6A illustrates an exemplary screen shot of the Control Center showing a real-time all TCP window in the user interface according to an embodiment of the present invention.

FIG. 6B illustrates another exemplary screen shot of the Control Center showing a real-time all TCP window in the user interface according to an embodiment of the present invention.

FIG. 7 illustrates an exemplary screen shot of the Control Center showing the user interface with a real-time web usage window according to an embodiment of the present invention.

FIG. 8 illustrates an exemplary screen shot of the Control Center showing the user interface with a real-time chat usage window according to an embodiment of the present invention.

FIG. 9 illustrates an exemplary screen shot of the Control Center showing the user interface with a real-time FTP usage window according to an embodiment of the present invention.

FIG. 10 illustrates an exemplary screen shot of the Control Center showing the user interface with a real-time e-mail usage window according to an embodiment of the present invention.

FIG. 11 illustrates an exemplary screen shot of the Control Center showing a reports and alerts window in the user interface according to an embodiment of the present invention.

FIG. 12 illustrates an exemplary screen shot of a graphical representation of e-mail exchange among employees of a company.

FIG. 13 illustrates an exemplary screen shot of a heavy e-mail users report, including tabular and graphical displays of information, according to an exemplary embodiment of the present invention.

FIG. 14 illustrates an exemplary screen shot of the Control Center showing a real-time computer information window according to an exemplary embodiment of the present invention.

FIG. 15 illustrates an exemplary embodiment of a system diagram for the present invention implemented in a Local Area Network environment according to an embodiment of the present invention.

FIG. 16 illustrates an exemplary embodiment of a device driver interface arrangement according to an embodiment of the present invention.

FIG. 17 illustrates an exemplary embodiment of an interaction between a server application and a device according to an embodiment of the present invention.

FIG. 18 illustrates an exemplary embodiment of blocks that make up an Ethernet frame structure according to an embodiment of the present invention.

FIG. 19 illustrates an exemplary embodiment of a format for an Ethernet data frame structure according to an embodiment of the present invention.

FIG. 20 illustrates an exemplary embodiment of a transmission control protocol structure according to an embodiment of the present invention.

### DETAILED DESCRIPTION OF THE INVENTION

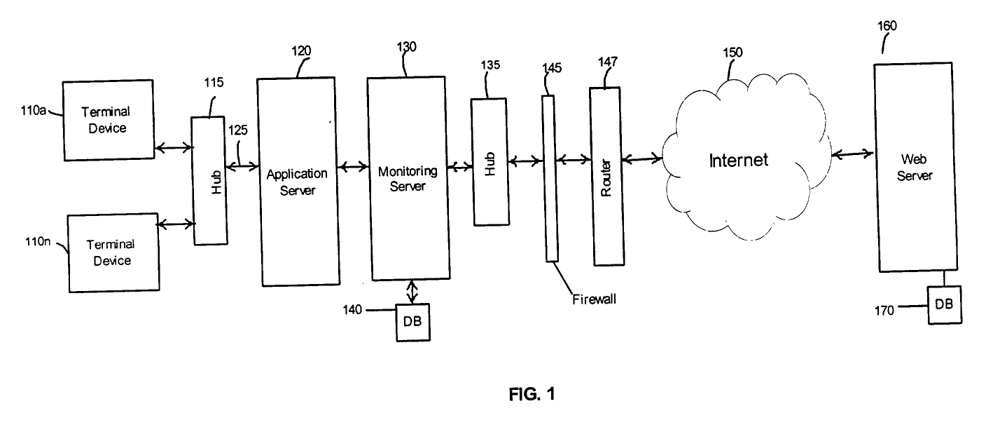

FIG. 1 illustrates an embodiment of the invention in a general computing environment. A plurality of terminal devices 110a-110n, for example, personal computers, personal digital assistants, cell phones, kiosks, etc., may be connected through a hub 115 to an application server 120 that is coupled to a monitoring server 130. The monitoring server 130 centrally tracks data passing through the communication line 125 in real-time by type, such as for example, Internet browsing, FTP, e-mail, instant messaging, chat, local area network communications, etc. In one embodiment, the monitoring server 130 is designed so that the terminal devices 110 do not need to have any software or hardware device installed therein to enable monitoring. As a result, the terminal devices 110 do not suffer a negative impact in performance. Furthermore, a user of terminal devices 110 cannot disable the monitoring system at the terminal devices.

The monitoring server 130 may be located at a network side of an application server 120, between the application server 120 and web servers 160, for example, to monitor activity over communication lines 125, for example, Internet lines, intranet lines, etc., and to capture data without affecting network performance. In a further embodiment, a firewall 145 and/or a router 147 may be inserted between the monitoring server 130 and the web server 160.

In an alternative embodiment, the monitoring server 130 may be located in the application server 120 to monitor communication between the application server 120 and the terminal devices 110. Specifically, the monitoring server 130 monitors and captures data packets that traverse the communication lines 125 between the terminal devices 110 and the application server 120. Each data packet that passes between the application server 120 and the terminal devices 110 includes an identification marker that identifies the type of data being sent. For example, printer data, facsimile data, file transfers, Internet transactions, etc., each have a unique identification marker that may be included with the data packet.

The monitoring server 130 scans the data packets passing through the communication lines 125 in search of predetermined identification markers and captures, in approximately real-time, those data packets having the predetermined identification markers. The term approximately real-time is defined to be within a reasonable time of the data packets passing through the communication lines 125 and may include, for example, capturing data instantaneous or capturing data within a reasonable delay. The captured data packets may be repackaged and sorted into categories in order to be displayed in real-time and/or may be stored in a database 140. Data packets that do not include the predetermined identification markers may not be repackaged by the monitoring server 130 and may either be discarded or saved in the database 140. The database 140 may be an integral part of the monitoring server 130. Alternatively, the database 140 may be external to the monitoring server 130. It should be readily understood that the physical location of the database 140 may be changed without adversely affecting the performance of the overall system.

The database 140 may be accessed and searched using a variety of techniques. For example, a structured query language (SQL) is a standard language for relational database management systems and may be used to communicate with the database 140 supporting the monitoring server 130. SQL statements may be used to perform tasks such as, for example, updating data on the database 140 and/or retrieving data from the database 140. Thus, a user may generate customized reports and alerts using SQL statements. It should be readily understood that other equally effective database accessing languages may be used to communicate with the database 140.

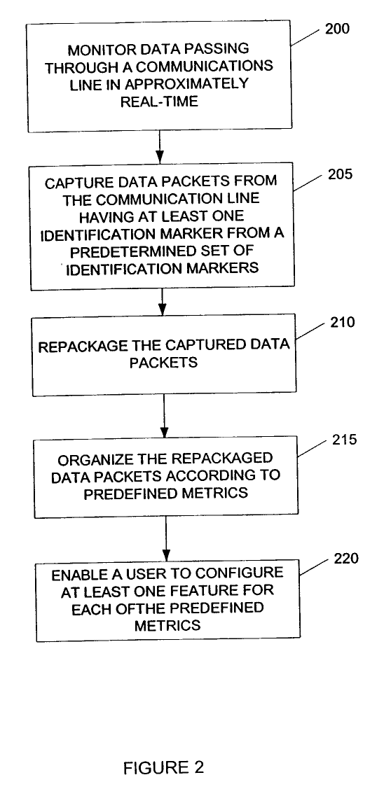

FIG. 2 illustrates a flow diagram of a generalized method for implementing the invention. In an operation 200, the communication lines 125 are monitored in real-time to identify data packets having at least one identification marker from a predetermined set of identification markers. In an operation 205, the data packets having one of the predetermined identification markers are captured. In an operation 210, the captured data packets are repackaged. In an operation 215, the repackaged data packets are organized according to predefined metrics. In an operation 220, a user is able to configure at least one feature for each of the metrics. In one embodiment, the repackaged data packets may be viewed in real-time in an operation. In an alternative embodiment, the repackaged data packets may be stored in the database 140 for subsequent viewing. In both cases, the data packets may be viewed in an organized and easy-to-read format.

In another embodiment of the invention, the data packets passing through the communication lines 125 and having the predetermined identification markers may be counted during a predefined time period and may be displayed by a control center. Furthermore, content of the data packets having the predetermined identification markers may be displayed by the control center. In a further embodiment, the control center may be designed to enable non-technical users to easily access the data packets in real-time.

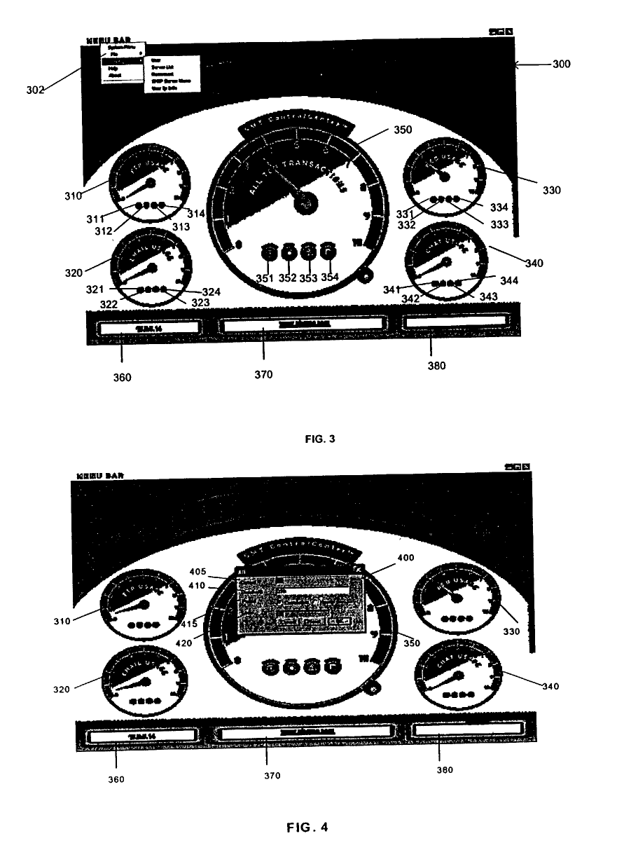

FIG. 3 illustrates an exemplary Control Center user interface 300 having a system menu 302 and dials that illustrate various metrics of Internet usage. The system menu 302, for example, may be a pull down menu that enables several operations to be performed on the Control Center. The dials may include, for example, a FTP usage dial 310, an e-mail usage dial 320, a web usage dial 330, a chat usage dial 340, and an all transmission control protocols (TCP) transactions dial 350. The all TCP transactions dial 350 may illustrate, for example, a weighted average of the total number of data packets and/or a weighted average of the total number of data transactions, which include several data packets, passing through the communication lines 125 during a predefined time period that have the predetermined identification markers, including, for example, FTP usage, e-mail usage, web usage, and chat usage. The Control Center interface 300 may also illustrate, for example, an Internet Protocol address 360 for a current connection, a Uniform Resource Locator (URL) 370 of the current connection, and a date and time 380 of last transaction processed.

Each dial (310, 320, 330, 340, 350) may include various buttons (311-314, 321-324, 331-334, 341-344, 351-354) therein associated with the respective dial, that enable a user to configure, for example, monitoring and notification features of the control center. For example, the buttons may be selected to activate corresponding monitoring windows including a real-time window, a set up window, and an alarm window, and/or to a notification window, including for example, a reports and alert window. Thus, the user may customize several aspects of the monitoring and notification features for each of the several dials. It should be understood that the invention is not intended to be limited solely to the exemplary applications shown. Rather, one skilled in the art will readily recognize that the invention may be configured to monitor or provide notification for any number of different applications.

In an exemplary embodiment, the set up window is displayed for the corresponding dial by pressing the set up button (312, 322, 332, 342, or 352). FIG. 4, for example, illustrates a set up window 400 as a pop-up window for the all TCP transactions dial 350. The all TCP set up window 400 may include an entry portion for several monitoring events. These may include, for example, a threshold value 410, a period for measuring the threshold value 415, and a scale 420 for displaying the number of data packets having the predetermined identification markers. The all TCP set up window 400 may also include the current number of data packets 405 having the predetermined identification markers of TCP transactions that are received during the present monitoring period. It should be readily understood that a greater number, lesser number, or different variety of entries may be provided in the set up window.

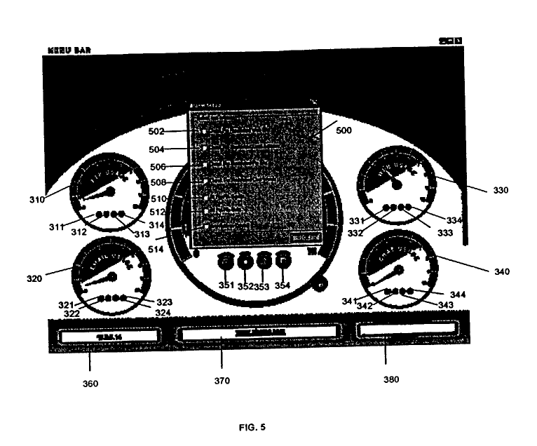

FIG. 5 illustrates an exemplary alarm set up window 500 for the all TCP transactions dial 350 as a pop-up window that enables the user to define one or more monitoring events that will trigger a notification message. In an exemplary embodiment, the alarm set up window 500 is displayed for the all TCP dial by pressing the alarm set up button 353. The alarm set up window 500 for the all TCP transactions dial 350 may include various boxes that are selected to notify a user when certain events occur. These events may include, for example, notification that a restricted web site is accessed 502, a restricted e-mail address is corresponded with 504, a restricted FTP site is accessed 506, restricted words are used in a chat room 508, any files are sent through FTP 510, any files are received through FTP 512, and any ActiveX controls are detected 514. It should be readily understood that a greater or lesser number of trigger events or other events may be provided in the alarm set up window 500. The alarm or warning button (313, 323, 333, 343) for the remaining dials (310, 320, 330, 340) enable a network administrator to add restricted chat words, e-mail addresses or domains, ftp sites, and URLs, for example, that cause the system to automatically notify the network administrator of users that have accessed content from the restricted lists.

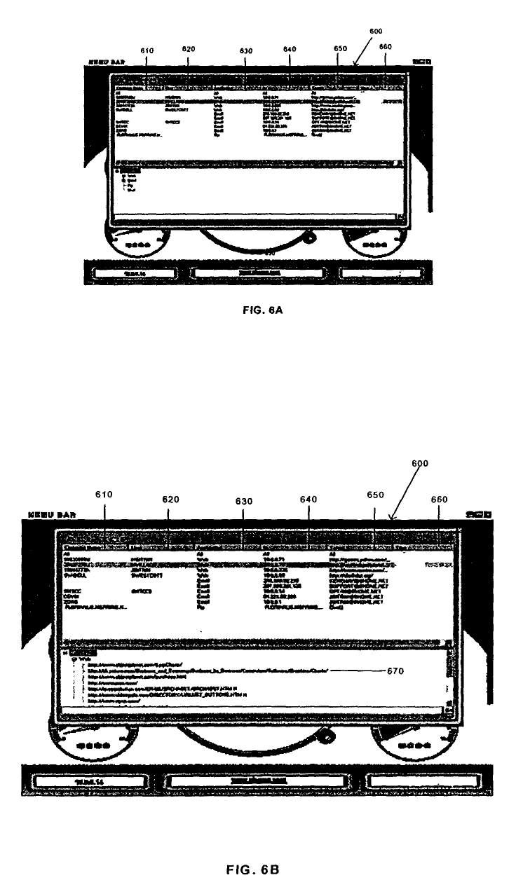

In another exemplary embodiment, real-time windows may be displayed for the corresponding dial by selecting a real-time button (311, 321, 331, 341, or 351). FIGS. 6-10, for example, respectively illustrate the real-time windows for the all TCP transactions dial 350, the web usage dial 330, the chat usage dial 340, the FTP usage dial 310, and the e-mail usage dial 320.

Upon selecting the real-time button 351 for the all TCP transactions dial 350, the real-time all TCP transactions window 600 may be displayed as illustrated in FIG. 6A. In an exemplary embodiment, the real-time all TCP transactions window 600 may include several categories that identify the real-time TCP transactions. For example, the following associated categories may be displayed to identify real-time TCP transactions: a computer name 610, a user name 620, an application 630, an Internet protocol (IP) address 640, a target site 650, and a date and time 660 of the transactions. FIG. 6B is an alternative embodiment of FIG. 6A illustrating a further list of Web sites 670 that were accessed during a predetermined period of time.

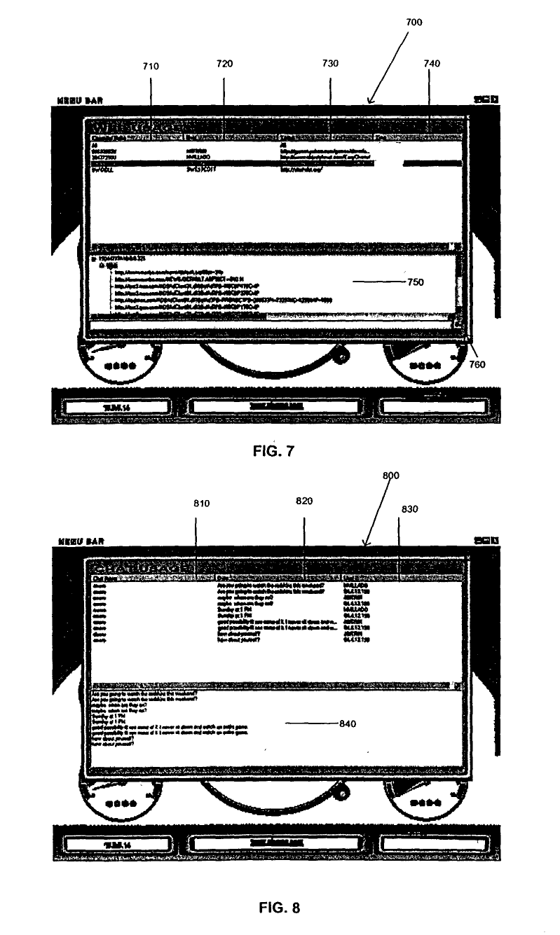

Upon selecting the real-time button 331 for the web usage dial 330, the real-time web usage window 700 may be displayed as illustrated in FIG. 7. In an exemplary embodiment, the real-time web usage window 700 may include several categories that identify the real-time web usage transactions. For example, the following associated categories may be displayed to identify real-time web usage transactions: a computer name 710, a user name 720, a target address 730, and a date and time 740 of the transaction. The invention further enables displaying and/or storing particulars of the web usage transactions. For example, a lower window in FIG. 7 illustrates URL sites 750 visited by the user. Box 760 will populate the URL selected in URL window 750 and the “go” button will execute the URL into a default web browser.

Upon selecting the real-time button 341 for the chat usage dial 340, the real-time chat usage window 800 may be displayed as illustrated in FIG. 8. In an exemplary embodiment, the real-time chat usage window 800 may include several categories that identify the real-time chat usage transactions. For example, the following associated categories may be displayed to identify real-time chat usage transactions: a chat room 810, data that is entered during the chat session 820, and users 830 accessing the chat room. The actual text of the chat session is listed in the data section 820 and in the lower window 840. The invention further enables displaying data of the chat session for each user participating in the chat session. FIG. 8, however, only illustrates data of the user associated with the monitored terminal device.

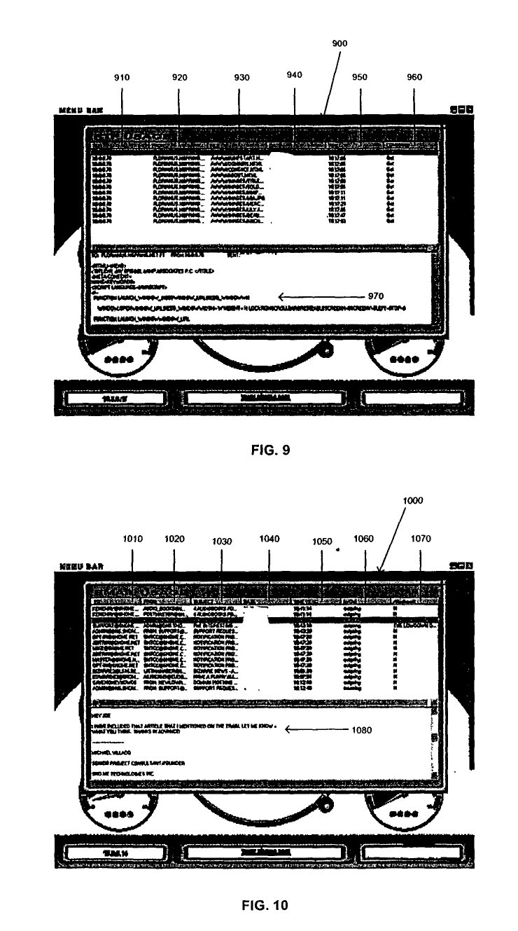

Upon selecting the real-time button 311 for the FTP usage dial 310, the real-time FTP usage window 900 may be displayed as illustrated in FIG. 9. In an exemplary embodiment, the real-time FTP usage window 900 may include several categories that identify the real-time FTP usage transactions. For example, the following associated categories may be displayed to identify real-time FTP usage transactions: a receiving address 910, a sending address 920, a file 930, a date 940, a time 950 and a command 960 for the file transfer protocols. In an exemplary embodiment, every file transfer may be monitored, including file transfers that are not initiated by a monitored party. The lower window 970 displays, for example, the FTP content and a description of the transaction.

Upon selecting the real-time button 321 for the e-mail usage dial 320, the real-time e-mail usage window 1000 may be displayed as illustrated in FIG. 10. In an exemplary embodiment, the real-time e-mail usage window 1000 may include several categories that identify the real-time e-mail usage transactions. For example, the following associated categories may be displayed to identify real-time e-mail usage transactions: a receiving address 1010, a sending address 1020, a subject 1030, a date 1040, a time 1050, whether the e-mail is incoming or outgoing 1060, and whether an attachment 1070 is included with the e-mail. In an exemplary embodiment, if an attachment is included with the e-mail, the name of the attachment may be included in the attachment column 1070. The lower window 1080 may illustrate, for example, e-mail routing information and the content of a selected e-mail message.

The data packets having the predetermined identification markers of TCP transactions that are associated with the various metrics of Internet usage, for example, may be organized into reports and alerts for real-time viewing by authorized users, such as, for example, network administrators or users with special privileges. In an alternative embodiment, the reports and alerts may be stored for subsequent viewing by authorized users. For example, the data packets having the predetermined identification markers of TCP transactions that are associated with the real-time windows for the all TCP transactions dial 350, the web usage dial 330, the chat usage dial 340, the FTP usage dial 310, and the e-mail usage dial 320 may be displayed in a reports and alerts window 1100 as illustrated in FIG. 11. The reports and alerts window 1100 provides authorized users with results of the real-time monitoring activities in organized and easy-to-read formats.

In an exemplary embodiment, the monitoring server 130 enables the authorized users to specify the amount of data to be viewed and/or stored in database 140. For example, an entire e-mail message may be viewed and/or stored in database 140 or an abridged version of e-mail data, such as header information only or message body content only, may be viewed and/or stored in database 140. Additionally or alternatively, the monitoring server 130 may be configured to enable the authorized users to select the type of data monitoring to be performed. In one embodiment, for example, the monitoring server 130 may be configured to exclude monitoring selected TCP transactions that are associated with the various metrics including, for example, chat, ftp, http and/or e-mail. In another embodiment, the monitoring server 130 may be configured to monitor all TCP transactions that are associated with the various metrics.

In another exemplary embodiment, the reports and alerts window may be displayed for the corresponding dial by pressing the reports button (314, 324, 334, 344, or 354). FIG. 11, for example, illustrates the reports and alerts window 1100 having various sections including a reports section 1101 and an alerts section 1150. The reports section 1101 may include links to various reports. For example, reports may be provided for: bandwidth use 1102, heavy web users 1104, most popular FTP sites 1106, e-mail content 1108, chat content 1110, heavy instant messaging (IM) users 1112, most popular e-mail hosts 1114, heavy FTP users 1116, heavy e-mail users 1118, most popular web sites 1120, heavy chat users 1122, and IM content 1124. The reports section 1101 may be further configured to enable authorized users to specify, for example: a start date 1126, a start time 1128, an end date 1130, an end time 1132, a number of results to be shown per page 1134, the level of detail to be displayed in the report, either a summary or detailed representation 1136, and whether to also display a graph with the report. In the exemplary embodiment shown in FIG. 11, the monitored user may be selected based on an e-mail address 1138 or a user name 1140. In some embodiments, an authorized user may monitor all the e-mail addresses or all the users by selecting the corresponding “All” box next to the e-mail addresses 1138 and user names 1140. It should be readily understood that greater or fewer numbers of reports and/or different types of reports may be provided in the reports section 1101.

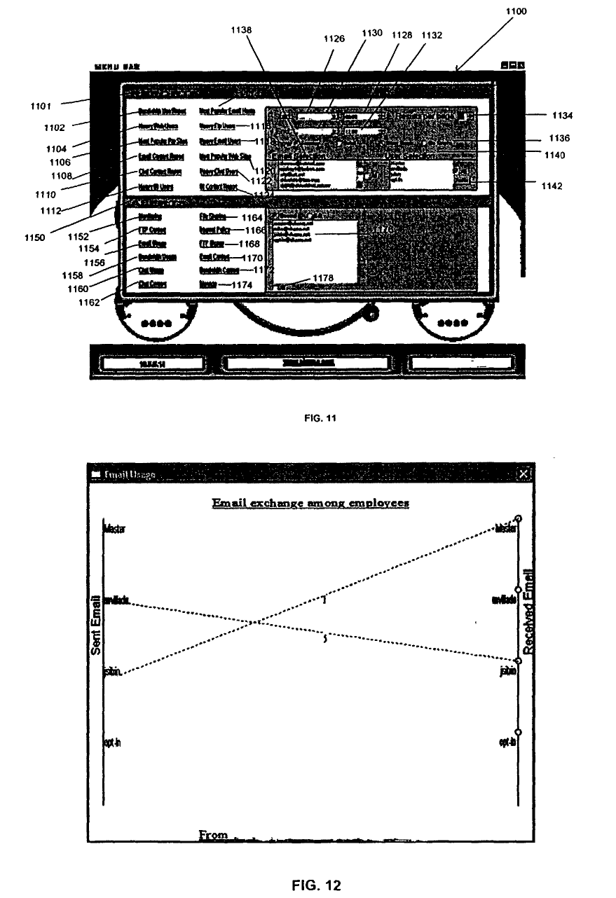

In another exemplary embodiment, reports section 1101 may further include a traffic button 1142 that launches a graphical illustration of e-mail exchange among company employees or e-mail exchange between a company employee and an external e-mail address. FIG. 12 illustrates a graphical representation of an e-mail exchange among employees of a company. In an exemplary embodiment, selected users that have sent e-mail are illustrated on the left hand side of the graph and the destination e-mail is illustrated on the right hand side of the graph for a given period of time. The number of messages sent between the users is illustrated in the middle of the graph proximate to the corresponding line. For example, five messages have been exchanged between mvillado and jsitrin.

Referring again to FIG. 11, the alerts section 1150 may includes links to various alerts. For example, alerts may be provided for: monitoring 1152, FTP content 1154, email usage 1156, bandwidth usage 1158, chat usage 1160, chat content 1162, file sharing 1164, Internet policy 1166, FTP usage 1168, e-mail content 1170, bandwidth content 1172, and manage 1174. In the exemplary embodiment shown in FIG. 11, the alerts section 1150 may also include an e-mail selection box 1176 to enable authorized users to select an individual e-mail address or a group of e-mail addresses that should receive a particular alert. The alerts may be shown in a general format or a format that enables the authorized users to edit the alert by inserting or deleting text. In some embodiments, an authorized user may send an alert message to all the e-mail addresses by selecting the corresponding “All” box 1178 proximate to the e-mail selection box 1176. It should be readily understood that greater or fewer numbers of alerts and/or different types of alerts may be provided in the alerts section 1150.

The monitoring server 130 may include an alarm configuration section that defines criteria for triggering an alert notification. In an exemplary embodiment, the monitoring server 130 may monitor and count data packets and/or data transactions having the predetermined identification markers that pass through the monitoring server 130 during a predetermined time interval. In another exemplary embodiment, if the monitoring server 130 determines that the number of data packets passing through the monitoring server 130 has increased by a preselected percentage, for example, then an alert notification may be triggered and sent to the authorized user.

An alert notification may be structured so that, for example, when a predetermined criteria is established or when an event is performed, the alert may be generated and categorized for viewing in the alerts section 1150 of the reports and alerts window 1100. Alternatively, the alert may be generated, categorized, and stored in the monitoring server 130 for subsequent viewing in the alerts section 1150 of the reports and alerts window 1100. In a further embodiment, the alert may be configured for automatic and/or instant notification to the authorized user, wherein the alert is generated, categorized, and sent to the authorized user through, for example, an instant e-mail alert, an instant facsimile alert, a pager, a cellular phone, or other instant messaging device.

In another embodiment of the invention, the monitoring server 130 may be configured to enable authorized users to add or remove users from monitoring activities that are used to generate reports. In a further embodiment, the authorized users may add or remove users from monitoring and notification activities that are used to generate alerts. In this way, the authorized users are provided with control over selecting the users that are targeted for reports and alerts.

After selecting the users to be monitored, the data packets having the predetermined identification markers that are associated with the various metrics that are used to generate the reports section 1101 and the alerts section 1150 of the reports and alerts window 1100 may be viewed in real-time. Alternatively, the data packets having the predetermined identification markers that are used to generate the reports section 1101 and the alerts section 1150 of the reports and alerts window 1100 may be stored in the database for subsequent viewing.

Various easy-to-read reports and alerts may be generated for the various data packets having the predetermined identification markers that are monitored to create the reports section 1101 and alerts section 1150 of the reports and alerts window 1100. For example, FIG. 13 illustrates an exemplary report for heavy e-mail users that is generated both in a tabular format 1300 and a graphical format 1320.

Table 1300 illustrates a detailed format of incoming e-mail for a user, John Brenner, who is monitored between defined hours on a defined date. Table 1300 may include several columns describing received e-mail. For example, columns may be provided to illustrate a sender's e-mail address 1302, a subject line for the e-mail message 1304, and a date and time the e-mail was received 1306.

In an alternative format, the reports may be presented in a variety of graphical formats as illustrated in the lower portion of FIG. 13. For example, graph 1320 illustrates a number of incoming messages 1322 received from known senders 1324. Graphical representations of an amount of time spent by the user at particular web sites may also be provided. For example, graph 1330 illustrates the percentage of time that a user spent at various web pages in pie chart format. In another embodiment, graph 1340 illustrates a number of minutes that a user spent at various web pages in a bar graph format. It is noted that FIG. 13 is provided for illustrative purposes only and is not intended to limit the scope of the invention. It should be readily understood that the information may be displayed in a variety of formats.

The invention may be operated in any network environment to monitor data packets having the predetermined identification markers. In an exemplary embodiment, the invention may be configured to track LOTUS notes and MICROSOFT Exchange. The invention may also be implemented using a JAVA version that enables monitoring of data packets from a remote location via a web browser using information hosted off of a web server

Additional features of the invention may include combining the monitoring system of the invention with existing filters that block access to restricted web sites using a database of categorized Web sites that allow or deny access to entire categories of Web sites or to individual Web sites.

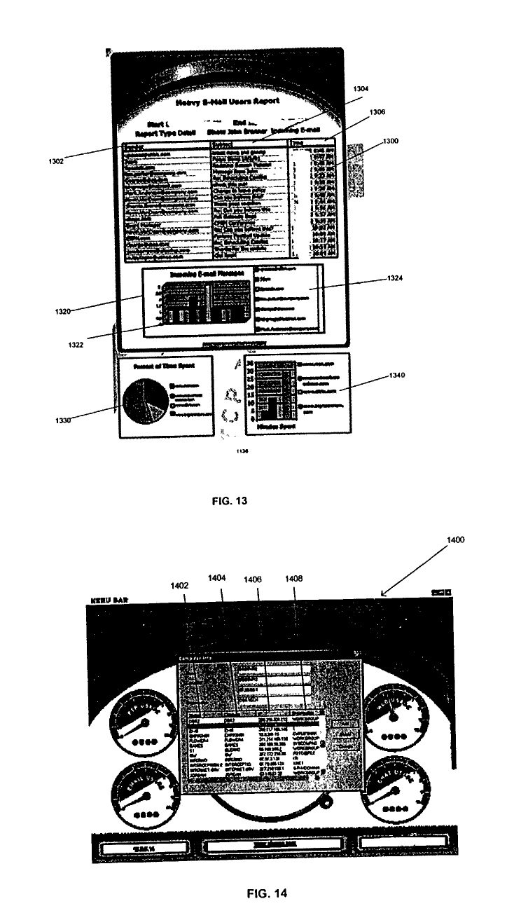

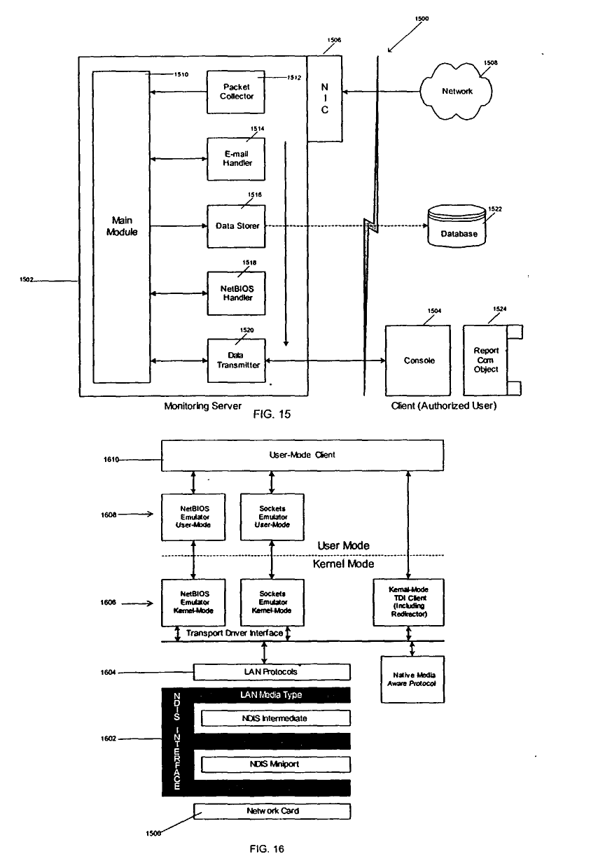

An additional feature of the invention may provide for establishing the identity of monitored users with a reasonable degree of certainty by using a multiple point check. FIG. 14 illustrates a computer information window 1400 having a user name 1402, a computer name 1404, a computer IP address 1406, and an organization name 1408. The monitoring server 130 is capable of obtaining the user name 1402, a computer name 1404, a computer IP address 1406, and an organization name 1408 and saving this information to database 140 for subsequent processing.

An exemplary embodiment of the invention is described below for a Local Area Network (LAN) environment. In such an embodiment, the Control Center may be implemented for an Ethernet monitoring software system that collects network data packets having predetermined identification markers, graphically renders the collected data packets in a user-friendly user interface, and stores the data packets in a relational database system for historical reporting.

FIG. 15 illustrates an embodiment of a system 1500 having a monitoring server 1502 configured to capture all data packets traveling in the Local Area Network (LAN) 1508 that are sent by client machines or nodes of the LAN 1508. In an exemplary embodiment, the data packets that are sent by client machines of network 1508 may be received by the monitoring server 1502 through an Ethernet Network Interface Card (NIC) 1506. Although not illustrated in FIG. 15, an NIC may be installed in each client machine of network 1508 to accept or reject the data packets that are processed by the monitoring server 1502, based on an examination of addressing information embedded in a header portion of each data packet.

In another exemplary embodiment of the invention, the data packets are received by a main module 1510 of the monitoring server 1502. A packet collector 1512 may access the data packets and route the data packets to appropriate handlers, such as, for example, an e-mail handler 1514, a NetBIOS handler 1510, etc. The main module 1510 may also send the data packets to a data storer 1516 for storage in a database 1522. Additionally, the main module 1510 may send the data packets to a data transmitter 1520 for transmission to a console 1504 operated by an authorized user, such as a network administrator. Reports and alerts 1524 may be generated based on the data packets received at the console 1504.

After receiving and processing the data packets in the monitoring server 1502, the data packets may be broadcast to all client machines in the network 1508. The Control Center utilizes this broadcasting feature of the monitoring server 1502 to view and store network activity information, such as, for example, volume and content of the data packets traveling in the network 1508.

In a further embodiment, the Ethernet NIC 1506 may be configured to operate in a Promiscuous mode to enable the monitoring server 1502 to capture all the data packets that are received by the NIC 1506. In this mode, the NIC 1506 accepts any data packets that are received and makes the data packets available to any application that requests the data packets. The combination of this user selectable card mode and the broadcast feature of the Ethernet protocol provide a basis for implementing the Control Center application.

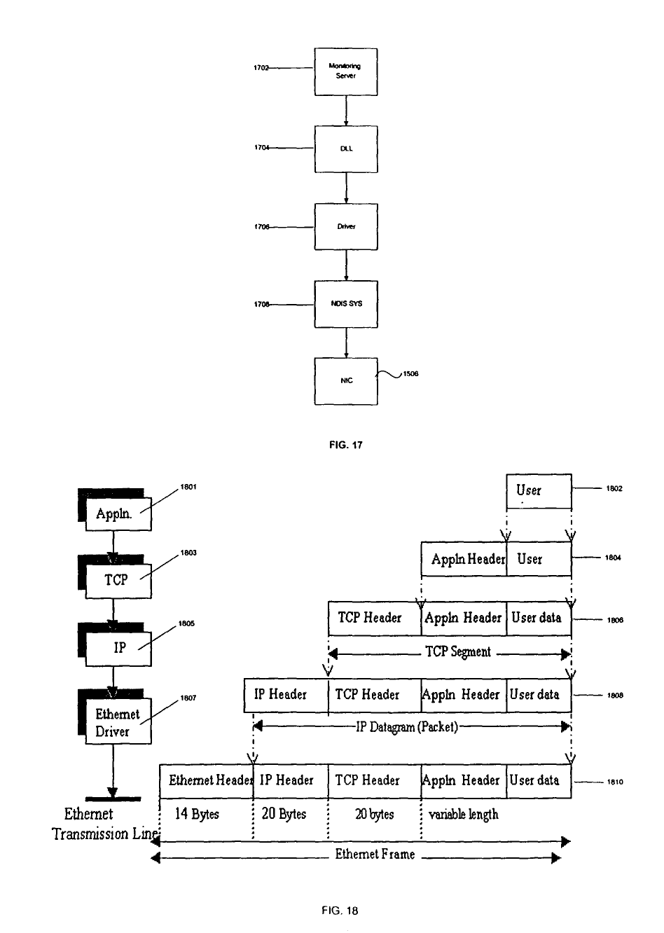

FIG. 16 illustrates an exemplary embodiment of Windows NT network driver components for translating a data packet received at the NIC 1506 to a user mode 1608 at the user-mode client 1610. A standard Network Driver Interface Specification (NDIS) interface 1602 may be provided to translate all the data packets received by the NIC 1506 at the monitoring server 1502 to LAN protocols 1604. The NDIS describes an interface by which one or more NIC drivers of NIC 1506 may communicate with one or more overlying protocol drivers 1604 and the operating system.

In an exemplary embodiment, the monitoring server 1502 places the NIC 1506 in the promiscuous mode to enable capturing all the data packets that travel in the network 1508. As illustrated in FIG. 17, the monitoring server 1702 accesses a dynamic link library (DLL) 1704 having a library of executable functions or data that may be used by a Windows application. Typically, a DLL provides one or more particular functions, and a program accesses the functions by creating either a static or dynamic link to the DLL. A static link remains constant during program execution while a dynamic link is created by the program as needed. The DLL 1704 activates a network driver 1706 to access a NDIS.SYS 1708, which is a file that may be written placing the NIC 1506 in promiscuous mode for monitoring all data packets received at the monitoring server 1502.

With the NIC 1506 in promiscuous mode, the Control Center may analyze the content of all the data packet received at the monitoring server 1502 and may select data packets having predetermined identification markers. For example, the Control Center may monitor the data packets having predetermined identification markers associated with web activity, such as for example, e-mail, ftp, chat, etc.

As illustrated in FIG. 18, a data packet may be configured as an Ethernet frame structure to include a TCP/IP protocol. In this embodiment, data generated by a user may be transformed to an Ethernet frame structure for transmission in the LAN 1508. Referring to FIG. 18, an application module 1801 may be provided to encapsulate user data (UD) 1802 and affix an application header to the user data 1802 to generate an application message 1804. A TCP module 1803 may be provided to encapsulate the application message 1804 and affix a TCP header to the application message 1804 to generate a TCP message 1806. An IP module 1805 may be provided to encapsulate the TCP message 1806 and affix an IP header to the TCP message 1806 to generate an IP data gram or IP data packet 1808. An Ethernet driver may be provided to encapsulate the IP data gram or IP data packet 1808 and affix an Ethernet header to the IP data gram or IP data packet 1808 to generate an Ethernet frame structure 1810.

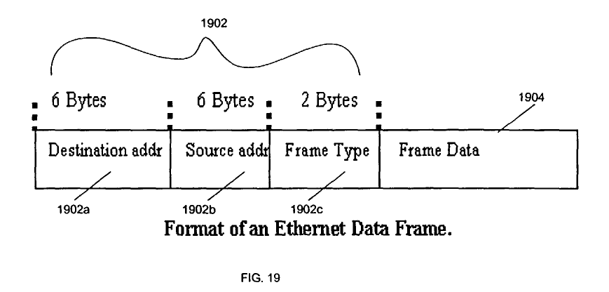

To identify a predetermined request, such as an HTTP request for example, the Ethernet frame structure 1810 is first reviewed by the monitoring server 1502 to detect the existence of a TCP/IP packet. As illustrated in FIG. 19, the Ethernet frame structure 1810 contains, for example, a 14-byte header followed by data. The frame type field 1902c identifies the overlying protocol of the Ethernet frame structure 1810. In this embodiment, IP data packets 1808 have a value of 08 0016 in the frame type field (bits 13 and 14). Next, the IP header may be parsed to identify TCP and/or UD packets. After identifying a data packet as being of a TCP type, the application that originated the data packet may be determined and the TCP type, such as for example, e-mail, ftp, chat, etc., may be identified and the content may be extracted.

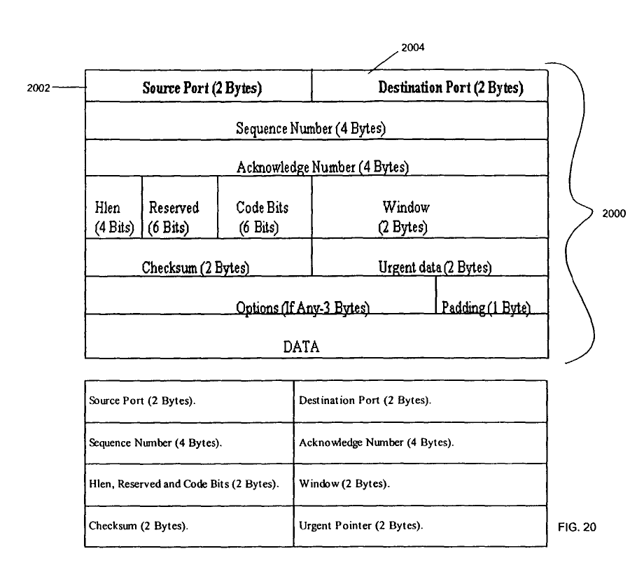

FIG. 20 illustrates a TCP header 2000 having a source port 2002 and a destination port 2004, for example, that specify a port to which a connection is established. Once a connection port is identified, the TCP transaction type, for example, HTTP, FTP, etc. may be determined from the connection port because the TCP transactions use specific port numbers to render their services. After determining the transaction type, the Control Center may also analyze both the content and traffic volume of a TCP transaction using the techniques described above.

While the preferred forms of the invention have been described, is it to be understood that modifications will be apparent to those skilled in the art without departing from the spirit of the invention. For example, the invention may be used to monitor any communications that include transaction protocols, such as telephonic communications, wireless communications, etc. The scope of the invention, therefore, is to be determined solely by the following claims.

What is claimed is:

1. A method of monitoring communication lines of a computer in approximately real-time, comprising:
monitoring data passing through the communication lines;
capturing data packets from the communication lines having at least one identification marker from a pre-determined set of identification markers;
repackaging the captured data packets;
organizing the repackaged data packets according to at least one predefined metric; and
enabling a user to configure at least one feature for each of the at least one predefined metric.

2. The method according to claim 1, wherein said capturing the data packets having the at least one identification marker from the pre-determined set of identification markers includes selecting data packets structured as one of at least a transmission control protocol and a user datagram protocol.

3. The method according to claim 1, wherein said monitoring data packets includes monitoring in real-time for an identification marker identifying at least one of an e-mail transaction, a file transfer protocol transaction, a web usage transaction, a chat usage transaction, and an instant messaging transaction.

4. The method according to claim 1, wherein the at least one predefined metric for viewing the repackaged data packets is defined to be at least one of a file transfer protocol usage transaction, an e-mail usage transaction, a web usage transaction, a chat usage transaction, and an all transmission control protocol transaction.

5. The method according to claim 4, wherein the at least one predefined metric for viewing the repackaged data packets is represented as at least one dial indicating a number of corresponding transactions passing through the communication lines.

6. The method according to claim 1, wherein the repackaged data packets are organized into at least one of a file transfer protocol usage transaction, an e-mail usage transaction, a web usage transaction, a chat usage transaction, and an all transmission control protocol transaction.

7. The method according to claim 1, wherein the user configures at least one monitoring feature for each of the at least one predefined metric.

8. The method according to claim 7, wherein the at least one monitoring feature includes at least one of a real-time window, a set-up window, and an alarm window.

9. The method according to claim 8, wherein each of the at least one of the real-time window, the set-up window, and the alarm window is different for each of the at least one metric.

10. The method according to claim 9, wherein each of the at least one of the real-time window, the set-up window, and the alarm window is displayed as pop-up window that enables the user to define one or more monitoring events.

11. The method according to claim 1, wherein the user configures a notification feature for each of the at least one predefined metric.

12. The method according to claim 11, wherein the notification feature includes at least a reports and alerts window.

13. The method according to claim 12, wherein the reports and alerts window is configured to automatically send an alert to an authorized user.

14. The method according to claim 13, wherein the alert is sent to the authorized user through at least one of an instant e-mail alert, an instant facsimile alert, a pager, and a cellular telephone.

15. The method according to claim 1, wherein the data packets are repackaged in real-time and transferred to a database for storage.

16. The method according to claim 1, wherein the data packets that correspond to the pre-determined set of identification markers are stored in a database, while the data packets that do not correspond to the pre-determined set of identification markers are not stored in the database.

17. A network communication monitoring system, comprising:
a first application server that is adapted to be coupled to a plurality of terminal devices for processing requests sent by the terminal devices;
a second application server that is coupled to the first application server and to an external source through communication lines, the second application server having one or more modules comprising:
a first module that monitors data passing through the communication lines in approximately real-time;
a second module that captures data packets from the communication lines having at least one identification marker from a pre-determined set of identification markers;
a third module that repackages the captured data packets;
a fourth module that organizes the repackaged data packets according to at least one predefined metric; and
a fifth module that enables a user to configure at least one feature for each of the at least one predefined metric.

18. The network communication monitoring system according to claim 17, wherein the second application server is located at a network side of the first application server.

19. The network communication monitoring system according to claim 17, further comprising a data base coupled to the second application server.

20. The network communication monitoring system according to claim 17, wherein the second module is adapted to store the data packets having at least one identification marker from the pre-determined set of identification markers and to discard the data packets that do not have at least one identification marker from the pre-determined set of identification markers.

21. The network communication monitoring system according to claim 19, wherein the second module is adapted to store the data packets having at least one identification marker from the pre-determined set of identification markers corresponding to at least one of a file transfer protocol transaction, an e-mail transaction, a web usage transaction, a chat usage transaction, and an all transmission control protocol transaction.

22. The network communication monitoring system according to claim 17, wherein the external source is an Internet.

23. The network communication monitoring system according to claim 22, wherein at least one identification marker from the pre-determined set of identification markers correspond to codes defining an Internet transaction.

24. An application server comprising:
a first module that monitors data passing through communication lines in approximately real-time;
a second module that captures data packets from the communication lines having at least one identification marker from a pre-determined set of identification markers;
a third module that repackages the captured data packets;
a fourth module that organizes the repackaged data packets according to at least one predefined metric; and
a fifth module that enables a user to configure at least one feature for each of the at least one predefined metric.

25. The network communication monitoring system according to claim 24, further comprising a database coupled to the application server.

26. The network communication monitoring system according to claim 24, wherein the second module is adapted to store the data packets having at least one identification marker from the pre-determined set of identification markers and to discard the data packets that do not have at least one identification marker from the pre-determined set of identification markers.

27. The network communication monitoring system according to claim 25, wherein the second module is adapted to store the data packets having at least one identification marker from the pre-determined set of identification markers corresponding to at least one of a file transfer protocol transaction, an e-mail transaction, a web usage transaction, a chat usage transaction, and an all transmission control protocol transaction.

28. A computer program product for enabling a computer to monitor data passing through a computer network, comprising:
software instructions for enabling the computer to perform predetermined operations;
a computer readable medium bearing the software instructions;
the predetermined operations comprising:
monitoring data passing through communication lines of the computer network in approximately real-time;
capturing data packets from the communication lines having at least one identification marker from a pre-determined set of identification markers;
repackaging the captured data packets;
organizing the repackaged data packets according to at least one predefined metric; and
enabling a user to configure at least one feature for each of the at least one predefined metric.

29. The computer program product according to claim 28, wherein the user configures a monitoring feature for each of the at least one predefined metric.

30. The computer program product according to claim 28, wherein the user configures a notification feature for each of the at least one predefined metric.

31. The computer program product according to claim 30, wherein the user configures the notification feature to automatically or manually send an alert to an authorized user.

32. A data transmission medium between a client and a server containing a data structure for monitoring data passing through the server, wherein the data structure includes instructions for enabling a computer to perform predetermined operations comprising:
monitoring data passing through communication lines of the computer network in approximately real-time;
capturing data packets from the communication lines having at least one identification marker from a pre-determined set of identification markers;
repackaging the captured data packets;
organizing the repackaged data packets according to at least one metric; and
enabling a user to configure at least one feature for each of the at least one metric.
